(19) United States
(12) Patent Application Publication
(10) Pub. No.: US 2018/0330224 A1
(43) Pub. Date: Nov. 15, 2018

(54) DIET INFORMATION RECOMMENDATION SYSTEM AND DIET INFORMATION RECOMMENDATION METHOD

(71) Applicant: SHUTTLE INC., Taipei City (TW)

(72) Inventors: Chong-Li LIU, Taipei City (TW); Jung-Chen TSAO, Taipei City (TW)

(21) Appl. No.: 15/648,458

(22) Filed: Jul. 13, 2017

(30) Foreign Application Priority Data
May 15, 2017 (TW) 106115918

(51) Int. Cl. G06N 3/04; G06Q 30/06; G06N 3/08; G06F 17/30; G06K 9/62; G06K 9/34; G06K 9/78; G06T 7/11; G09B 19/00; G09B 5/02

(52) U.S. Cl. CPC G06N 3/0427; G06Q 30/0639; G06Q 30/0623; G06N 3/08; G06F 17/30542; G06K 9/6256; G06T 2207/30128; G06K 9/78; G06T 7/11; G06K 9/628; G09B 19/0092; G09B 19/00; G09B 5/02; G06K 9/344

(57) ABSTRACT

A diet information recommendation system and a diet information recommendation method, wherein the system includes at least a matching platform, a database and an application installed in a user terminal. A large number of neurons are set up in advance in the database, and each neuron respectively comprises a picture and a corresponding name. The method includes: capturing a photo of food through the user terminal; connecting to the matching platform and uploading the photo to the matching platform through the application while an user is eating; performing a fuzzy matching between the photo and the neurons of the database for identifying the food in the photo and sending data associated with the food to the user terminal by the matching platform; and generating a corresponding diet recommendation according to the identified food and sending the diet recommendation to the user terminal by the matching platform.

### BACKGROUND OF THE INVENTION

### Field of the Invention

The present invention relates to a recommendation system and a recommendation method, in particular relates to a diet information recommendation system and a diet information recommendation method.

### Description of Prior Art

In recent years, people enjoy higher living standards and pay extra attention to health issues. Fitness is a growing trend and people focus more and more on health diet (for example, people may request to use organic food or record diet calories of meals).

However, various restaurants have different management systems towards meals offered, and most of the restaurants do not provide meal associated information (such as meal portions and calories etc.), which can be extremely inconvenient to consumers in need of diet control.

As mentioned above, some consumers preset one's own fitness/weight loss targets. Future diet or fitness plans may need adjustment once excess calories are taken or they may not be able to achieve set targets. It is a pity that there is no effective system or method in the prior art to assist consumers to conveniently and promptly accomplish the above mentioned object.

### SUMMARY OF THE INVENTION

The objective of the present invention is to provide a diet information recommendation system and a method there of, where users directly obtain the associated data of food via food photos and receive a diet recommendation generated based on the user data by the system.

In order to achieve the above objective, the diet information recommendation system of the present invention comprises at least a database, a matching platform, and an application installed in a user terminal, wherein a large number of neurons are setup in advance in the database, and each neuron respectively comprises a picture and a corresponding name. The diet information recommendation method captures a photo of food through the user terminal, connects to the matching platform and uploads the photo to the matching platform through the application while an user is eating; Next, the matching platform performs a fuzzy matching between the photo and the neurons of the database for identifying the food in the photo and sends data associated with the food to the user terminal by the matching platform; Next, the matching platform generates a corresponding diet recommendation according to the identified food and sending the diet recommendation to the user terminal.

In order to achieve the above objective, the diet information recommendation method at least comprises following steps:

a) the application uploading a photo of a food captured by the user terminal to the matching platform;

b) the matching platform performing a fuzzy matching between the photo and the plurality of neurons in the database to generate a matching result to send to the application, wherein each neuron respectively comprises a picture and a corresponding name, the matching result at least comprises the name of the food;

c) the matching platform inquiring the database according to the name of the food to obtain food data corresponding to the food, and sending the food data to the application;

d) the matching platform obtaining user data corresponding to the account number of the application from the database; and

e) generating a diet recommendation according to the user data and the food data to send to the application.

In comparison with prior art, the system and method of the present invention provides a technical advantage that users are allowed to conveniently and promptly access food associated data and receives a diet recommendation based on the user's personal data from the system which helps the users to control daily diet.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a system architecture diagram of a diet information recommendation system according to the first embodiment of the present invention;

FIG. 2 is a database schematic diagram according to the first embodiment of the present invention;

FIG. 3 is a neuron set up flowchart according to the first embodiment of the present invention;

FIG. 4 is a diet information recommendation flowchart according to the first embodiment of the present invention;

FIG. 5A is a usage schematic diagram according to the first embodiment of the present invention;

FIG. 5B is an information displaying schematic diagram according to the first embodiment of the present invention;

FIG. 6 is a neuron update flowchart according to the first embodiment of the present invention;

FIG. 7 is a photo process flowchart according to the first embodiment of the present invention;

FIG. 8 is a photo process flowchart according to the second embodiment of the present invention;

FIG. 9 is a diet information recommendation flowchart according to the second embodiment of the present invention; and

FIG. 10 is a system architecture diagram of a diet information recommendation system according to the second embodiment of the present invention.

### DETAILED DESCRIPTION OF THE INVENTION

In cooperation with attached drawings, the technical contents and detailed description of the present invention are described thereinafter according to a preferable embodiment, being not used to limit its executing scope. Any equivalent variation and modification made according to appended claims is all covered by the claims claimed by the present invention.

A diet information recommendation system is disclosed in the present invention (referred as a recommendation system hereinafter), which is used for receiving uploaded food photos from users, provide food associated information of the food taken by the users after a matching and an analysis, and offer a personal diet recommendation to individual user, which helps the users to perform diet control.

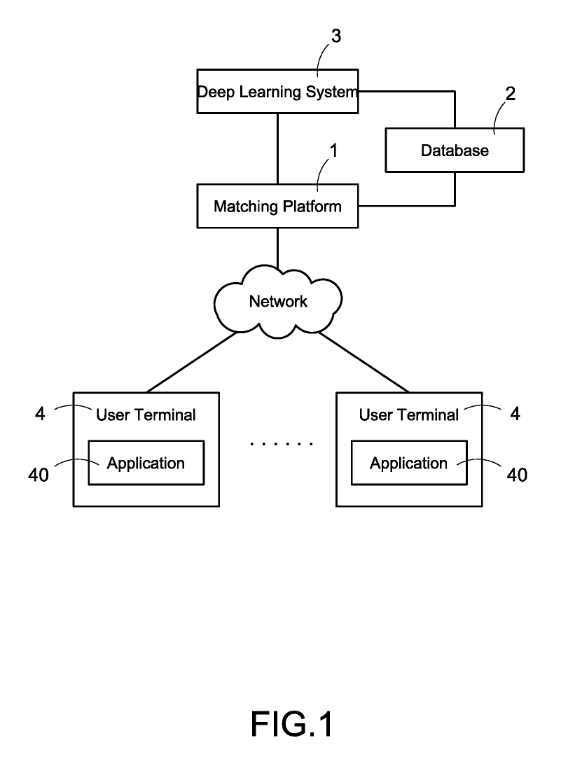

FIG. 1 is a system architecture diagram of a diet information recommendation system according to the first embodiment of the present invention. As shown in FIG. 1, the recommending system of the present invention at least comprises a matching platform 1, a database 2 and an application 40, wherein the matching platform 1 connects to the database 2, and the application 40 is installed and executed by a user terminal 4 belong to an user.

In the recommendation system according to the present invention, the application 40 is provided by the recommendation system developer and the user downloads the application 40 to install in the user terminal 4. Thus, the user terminal 4 establishes a connection with the matching platform 1 via executing the application 40.

In an embodiment, the user controls the user terminal 4 to capture a food photo with the camera lenses of the user terminal 4, and uploads the photo to the matching platform 1 via the application 40. The matching platform 1 performs matching recognition on the photo uploaded by the application 40 to recognize the food in the photo, and further sends the food associated information to the application 40. Thus, the application 40 displays the above mentioned associated information via the screen of the user terminal 4 for the user to review.

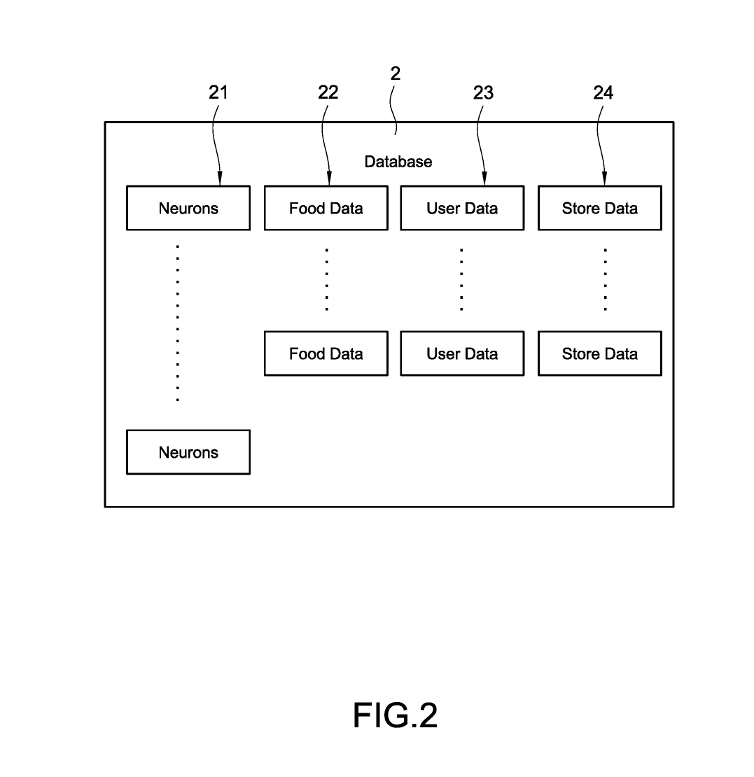

FIG. 2 is a database schematic diagram according to the first embodiment of the present invention. As shown in FIG. 2, at least a plurality of neurons 21 set up in advance are saved in the database 2, wherein each neuron 21 respectively comprises a picture and a name corresponding to the picture.

Specifically, the recommendation system also comprises a deep learning system 3 connected to the matching platform 1 and database 2. In an embodiment, the deep learning system 3 respectively sets corresponding names for all pictures uploaded to the database 2, and categorizes each picture according to the set names in order to set up the plurality of neurons 21.

In the embodiment, the pictures in the database 2 are pictures of various foods, such as a steak, a pork chop, an orange, a banana, an apple, a mushroom, a carrot, red wine, white wine etc. As mentioned above, the deep learning system 3 categorizes according to the name of each picture, or categorizes according to the category of each picture (for example meat category, fruit category, vegetable category, beverage category etc.), but the scope is not limited thereto.

The matching platform 1 receives the above mentioned photo from the application 40 and performs a fuzzy matching between the photo and the plurality of neurons 21 in the database 2. In addition, the matching platform 1 generates a matching result after the fuzzy matching is completed and sends the matching result to the application 40. In the embodiment, the matching result comprises at least the name of the food in the above mentioned photo. Thus, the application 40 displays the matching result (i.e., the above mentioned associated information) via the screen of the user terminal 4 to inform the user the name of the food in the photo, and the user may further determines if the matching result from the matching platform 1 is correct. The fuzzy matching is a known technique in the technical field and the description is omitted.

The matching platform 1 may further inquire the database 2 according to the name of the food generated from the fuzzy matching to obtain food data 22 of the food from the database 2 and sends the food data 22 to the application 40. Thus, the application 40 displays the food data 22 via the screen of the user terminal 4 for the user to review the associated information of the food. In an embodiment, the food data 22 can be the weight, calories, nutrition of the food in the photo, but the scope is not limited thereto.

In another embodiment, the user executes the application 40 in the user terminal 4 and is required to log on with a user account (for example, input a user account number and a password). In addition, the application 40 establishes a connection between the user terminal 4 and the matching platform 1 after confirming the account number of the user is correct.

In the embodiment, the matching platform 1 may obtain the account number of the user from the application 40, and inquire the database 2 with the account number of the user to obtain user data 23 corresponding to the user. In the embodiment, the user data 23 comprises the age, the height, the weight, the blood pressure and the body fat etc. of the user. Thus, the matching platform 1 may generate a diet recommendation according to both the user data 23 and the food data 22 after the fuzzy matching is completed, and the matching platform 1 then sends the generated diet recommendation to the application 40.

Also, the application 40 displays the above mentioned diet recommendation via the screen of the user terminal 4 for the user to understand and adjust the following diet plan. For example, the matching platform 1 may remind the user to take non-sugar beverages, informs the user of the after-meal options, the remained daily calories intake amount etc. in the above mentioned diet recommendation, but the scope is not limited thereto.

It should be noted that the above mentioned user data 23 may further record a current fitness plan of the user (for example the expected exercise date, the exercise item and the exercise duration etc.). In the embodiment, the matching platform 1 may generate a future fitness plan according to both the user data 23 and the food data 22 after obtaining the above mentioned user data 23, and sends the generated future fitness plan to the application 40.

In the embodiment, the matching platform 1 determines if the weight and the calories of the intake food have effects on the fitness/weight loss target of the user according to the food data 22, and adjusts the current fitness plan in the user data 23 to generate the future fitness plan if the determining result is positive. Thus, the application 40 displays the generated future fitness plan via the screen of the user terminal 4 to assist the user to consume the increased intake calories from eating the above mentioned food with the following exercises recorded in the future fitness plan.

With the above mentioned techniques, when the user accidentally takes excess calories and may fail to achieve the preset fitness/weight loss target, the recommendation system of the present invention may reduce the impact of the excess diet on the user by automatically adjusting the fitness plan. For example, when the intake calories of the user is higher than standard amount, the matching platform 1 increases the exercise days, extends the exercise durations, or reassigns the exercise items to generate the future fitness plan. Thus, the calories consumed by the user via conforming to the adjusted fitness plan can be effectively increased in the following time period.

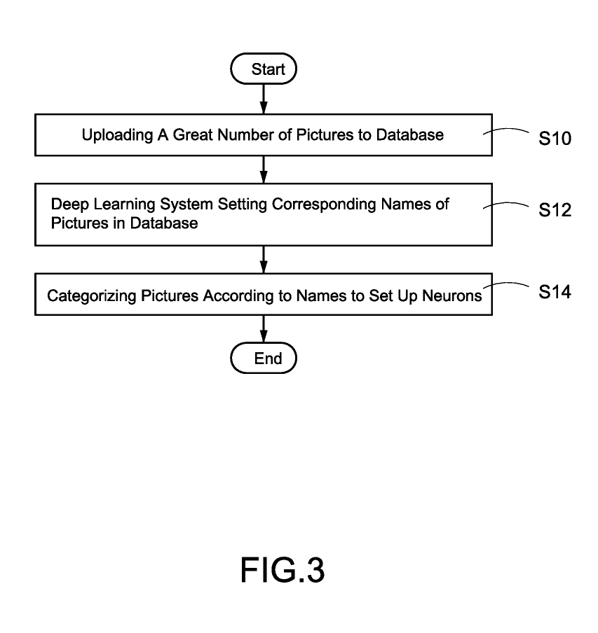

FIG. 3 is a neuron set up flowchart according to the first embodiment of the present invention. In the recommendation system of the present invention, the recommendation system developer uploads a great number of pictures to the database 2 (step S10). Specifically, the pictures are pictures of foods of various food categories. Next, the deep learning system 3 sets corresponding names (i.e. the name of the food in each picture) of the pictures in the database 2 (step S12), and categorizes the pictures according to the set names of the pictures in order to set up the plurality of neurons 21 (step S14).

In an embodiment, the deep learning system 3 performs picture recognition on the pictures in the database 2 via known picture recognition algorithms to obtain the name of the food in each picture. In another embodiment, the deep learning system 3 is operated by an administrator, and the names of pictures in the database 2 are directly set by the administrator. Next, the deep learning system 3 performs learning according to the pictures and the names of the pictures, which facilitates the subsequent fuzzy matching by the matching platform 1.

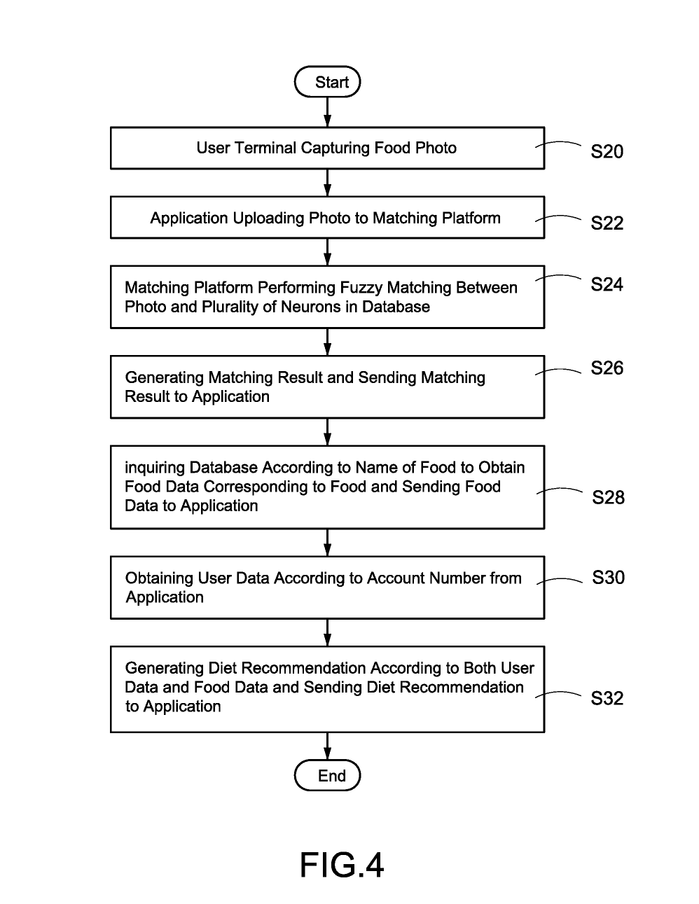

FIG. 4 is a diet information recommendation flowchart according to the first embodiment of the present invention. Further, a diet information recommendation method is disclosed in the present invention (referred as recommendation method hereinafter) which is used in the recommendation system shown in FIG. 1.

To implement the recommendation method according to the present invention as shown in FIG. 4, a user has to install and execute an application 40 in a user terminal 4, and uses the camera lenses (not shown in the diagrams) of the user terminal 4 to capture a photo of food while the user is eating (step S20), and then uploads the photo to a matching platform 1 via the application 40 (step S22).

The matching platform 1 receives the photo from the application 40 and performs a fuzzy matching between the photo and the plurality of neurons 21 set up in advance in the database 2 (step S24). In addition, the matching platform 1 generates a matching result after the fuzzy matching is completed and sends the matching result to the application 40 (step S26), wherein the matching result comprises at least the name of the food in the photo. Further, the application 40 displays the matching result via the screen of the user terminal 4 for the user to review.

After sending the matching result to the application 40, the matching platform 1 automatically executes the following actions, or executes the following actions after receives a trigger signal sent by the user via the application 40 to provide further detailed information to the application 40 for the user to review.

Specifically, the matching platform 1 inquires the database 2 according to the name of the food to obtain the food data 22 corresponding to the food in the photo (for example a steak or an apple) from the database 2 and sends the obtained food data 22 to the application 40 (step S28). Further, the application 40 displays the received food data 22 via the screen of the user terminal 4 for the user to review. In an embodiment, the food data 22 can be the weight, calories, nutrition, etc. of the food.

Also, the matching platform 1 may obtain the account number which the user uses to log on the application 40 from the application 40 when establishing a connection with the application 40, and inquires the database 2 with the account number to obtain the user data 23 corresponding to the account number (step S30). Next, the matching platform 1 generates a diet recommendation according to both the user data 23 and the food data 22 and sends the diet recommendation to the application 40 (step S32). Further, the application 40 displays the received diet recommendation via the screen of the user terminal 4 for the user to review.

In an embodiment, the user data 23 comprises the current fitness plan of the user. Alternatively, the matching platform 1 generates a future fitness plan according to both the user data 23 and the food data 22 and sends the generated future fitness plan to the application 40 (step S32). Further, the application 40 displays the future fitness plan via the screen of the user terminal 4 for the user to review.

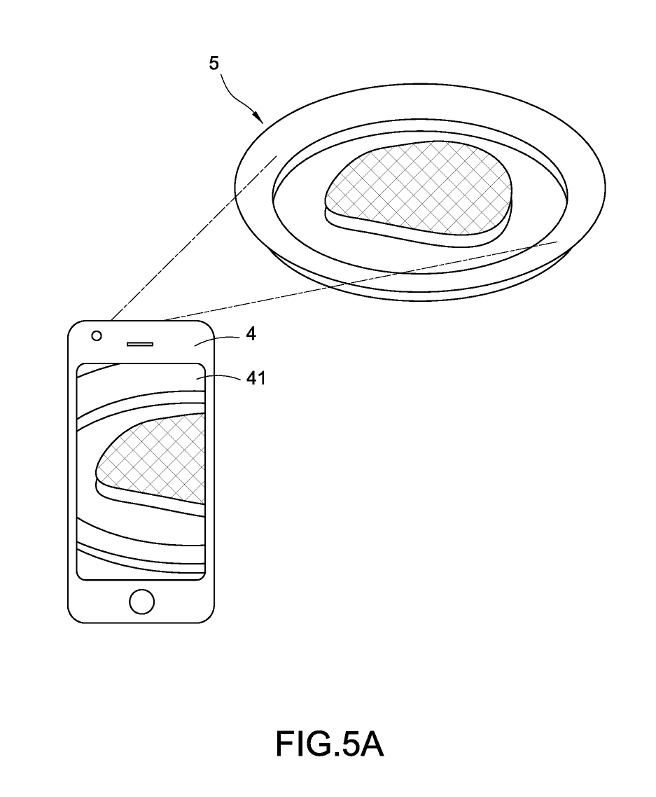

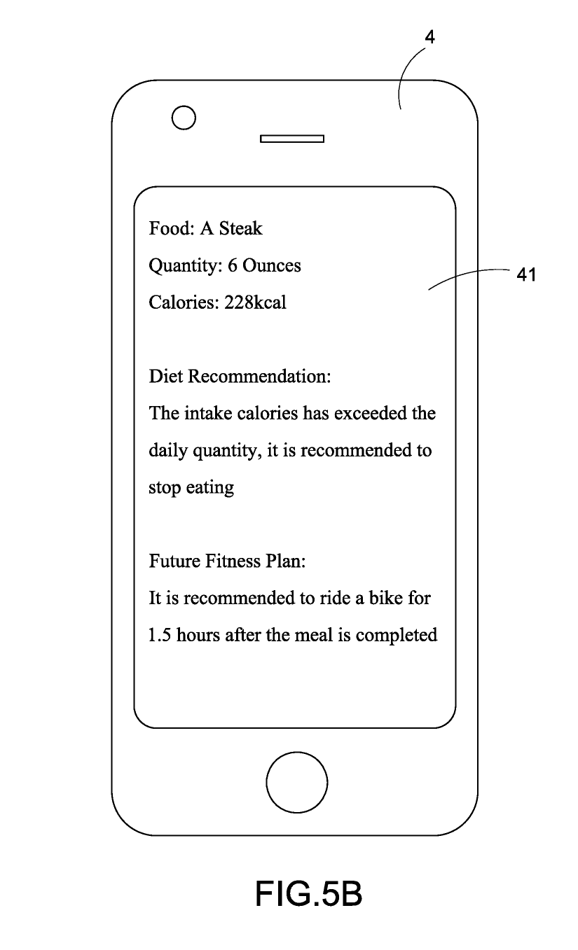

FIGS. 5A and 5B are a usage schematic diagram and an information displaying schematic diagram according to the first embodiment of the present invention. As shown in FIG. 5A, the user captures a photo of the food 5 with a user terminal 4 while the user is eating the food 5, and uploads the photo via the application 40 to the matching platform 1 to perform a fuzzy matching. In the embodiment, the exemplary food 5 is a steak, but the scope is not limited thereto.

Next, as shown in FIG. 5B, after completing the fuzzy matching, the matching platform 1 may selectively send the above mentioned matching result, the food data 22, the diet recommendation and the future fitness plan to the application 40 to display via a screen 41 of the user terminal 4 for the user to review. In the embodiment, the matching result comprises the name of the food 5: “a steak”; the food data 22 comprises the weight of the food 5 (such as 6 ounces) and the calories (such as 228 kcal) of the food 5; the diet recommendation comprises: “The intake calories has exceeded the daily quantity, it is recommended to stop eating.”; and the future fitness plan comprises: “It is recommended to ride a bike for 1.5 hours after the meal is completed.”. Though, the above mentioned description is one of the exemplary embodiments according to the present invention and the scope of the invention is not limited thereto.

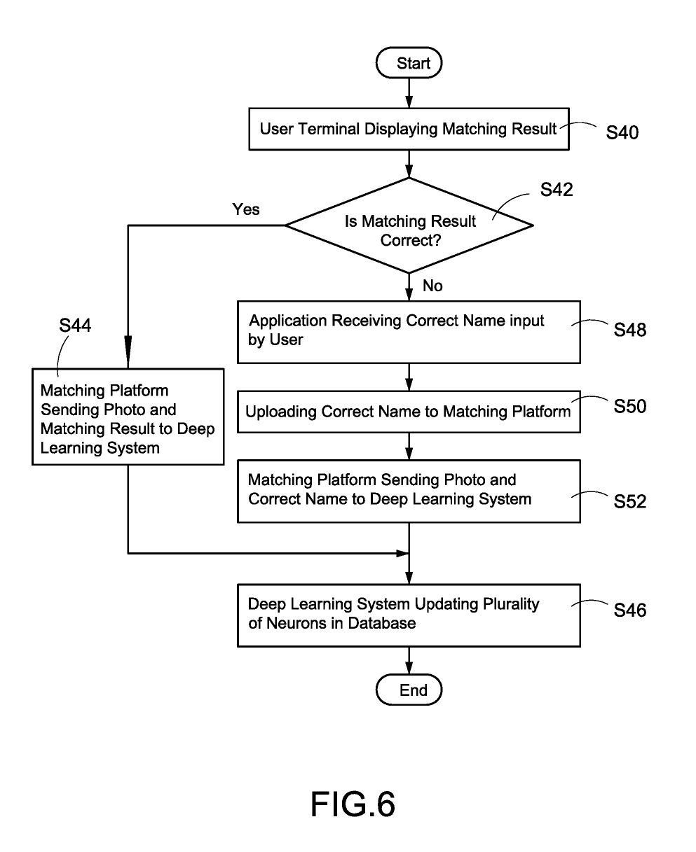

FIG. 6 is a neuron update flowchart according to the first embodiment of the present invention. According to the present invention, there are a great number of neurons 21 are set up in advance in the database 2. After the matching platform 1 performs the fuzzy matching on the photo uploaded by the user and obtains the matching result, the recommendation system further updates the neurons 21 in the database 2 according to the matching result in order to increase the accuracy of the fuzzy matching. Based on the experiment results by the inventors of the present invention, if the quantity of the neurons 21 set up in advance in the database 2 is sufficient, the accuracy of the fuzzy matching provided by the recommendation system in a short-term period usage is about 75%, and the accuracy of the fuzzy matching will be raised to 97% or so in a long-term period usage (such as one year) if the user keeps updating the database 2.

As shown in FIG. 6, the application 40 firstly receives the matching result of the photo from the matching platform 1 and displays the matching result on the screen 41 of the user terminal 4 (step S40). Next, the application 40 or the user determines if the matching result is correct (step S42), i.e. if the name in the matching result is the real name of the food 5. In an embodiment, the user controls a user interface in the user terminal 4 (such as buttons or a touch screen etc.) in order to perform feedback actions to indicate the matching result is correct or incorrect.

If the matching result is correct, the application 40 sends a correct feedback signal to the matching platform 1. Thus, the matching platform 1 directly sends the photo and the matching result to the deep learning system 3 (step S44), and the deep learning system 3 updates the plurality of neurons 21 in the database 2 according to the photo and the matching result (step S46). Specifically, the deep learning system 3 sets up new neuron 21 according to the photo and the matching result, and saves the new neuron 21 in the corresponding category data folder in the database 2.

If the matching result is incorrect, the application 40 sends an incorrect feedback signal to the matching platform 1. In the embodiment, the application 40 may receive a correct name input via the user interface in the user terminal 4 by the user (step S48), and uploads the correct name to the matching platform 1 (step S50). In the embodiment, the matching platform 1 sends the photo and the correct name input by the user to the deep learning system 3 (step S52), and the deep learning system 3 updates the plurality of neurons 21 in the database 2 according to the photo and the correct name (step S46).

In addition, if the matching result is incorrect, the matching platform 1 obtains the above mentioned correct name, then re-obtain and provide the above mentioned information such as the food data 22, the diet recommendation and the future fitness plan etc. according to the correct name. With the techniques shown in the embodiment in FIG. 6, the user is able to avoid receiving incorrect information with correcting the name of the food when the matching result of the fuzzy matching is incorrect, and increase the recognition accuracy of the matching platform 1 with continuously training the neurons 21.

It should be note that, in an embodiment, the matching platform 1 performs one or multiple fuzzy matchings on the photo to generate one or fuzzy multiple matching results, and generates a final matching result by compiling statistics according to one or multiple fuzzy matching results. Among which, the final matching results includes one or multiple names generated according to the one or multiple fuzzy matching results and the probability percentage of each names. Specifically, the matching platform 1 performs one or multiple fuzzy matchings according to at least one of the parameters such as the shape, the color, the surface status, the dimension, the cooking method and the recipe of a food image in the photo and obtains one or multiple fuzzy matching results.

For example, the matching platform 1 performs a first fuzzy matching according to the shape of the food image and obtains a first fuzzy matching result: “orange”; performs a second fuzzy matching according to the color of the food image and obtains a second fuzzy matching result: “orange”; performs a third fuzzy matching according to the surface status of the food image and obtains a third fuzzy matching result: “orange”; performs a fourth fuzzy matching according to the dimension of the food image and obtains a fourth fuzzy matching result: “apple”; and performs a fifth fuzzy matching according to the cooking method of the food image and obtains a fifth fuzzy matching result: “orange”.

In the above mentioned embodiment, four out of five fuzzy matching results indicate that the food 5 in the photo is an orange and only one fuzzy matching result indicates that the food 5 in the photo is an apple. Accordingly, the final matching result generated according to the complied statistics is for example: “orange probability 80%, apple probability 20%”. Though, the above mentioned is one of the exemplary embodiments according to the present invention and the scope of the invention is not limited thereto.

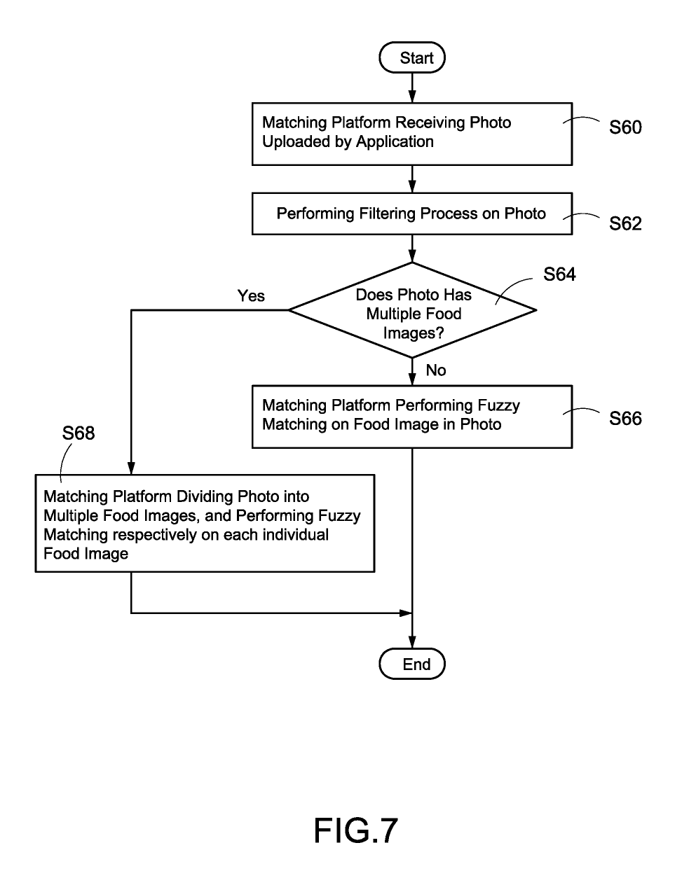

FIG. 7 is a photo process flowchart according to the first embodiment of the present invention. In some examples, the photos captured by the user may comprise objects other than the food 5 (for example tables, plates etc.), or there are multiple kinds of the food 5 in one picture. The recommendation system according to the present invention is able to perform pre-process on the photo according to the process flow shown in FIG. 7 in order to increase the recognition accuracy of the matching platform 1.

Specifically, the matching platform 1 firstly receives the photo uploaded by the application 40 (step S60), then performs a filer process on the photo to remove the unnecessary information besides the food image in the photo (step S62). In the embodiment, the matching platform 1 analyzes the food image and the unnecessary information in the embodiment via known image recognition algorithms. The unnecessary information refers to the images besides the food such as people, tables, plates, utensils etc., but the scope is not limited thereto.

Next, the matching platform 1 further determines if the photo has multiple food images (step S64). Specifically, the matching platform 1 analyzes the photo via known image recognition algorithms to determine if the photo has a single food image or multiple food images at the same time.

If the matching platform 1 determines that the photo does not have multiple food images, the matching platform 1 directly performs the fuzzy matching on the food image in the photo as shown in step S24 in FIG. 4 (step S66). Though, if the matching platform 1 determines that the photo has multiple food images, the matching platform 1 first divides the multiple food images in the photo to generate multiple individual food images and respectively performs the fuzzy matching on the multiple individual food images in the photo as shown in step S24 in FIG. 4 (step S68).

For example, if the photo has two food images (for example has a stake as the main dish and the broccolis as the side dish), the matching platform 1 divides the two food images and then performs a first fuzzy matching on the stake image and a second fuzzy matching on the broccolis image. In addition, the fuzzy matching operations can be executed sequentially or simultaneously, but the scope is not limited thereto.

With the above mentioned techniques, the recommendation system of the present invention provides multiple food data 22 corresponding to the multiple foods 5 in a single photo, and provides an integrated diet recommendation and a future fitness plan based on the multiple food data 22. Thus, the user is not required to individually capture and upload multiple photos respectively for the multiple foods 5, which is convenient to the user.

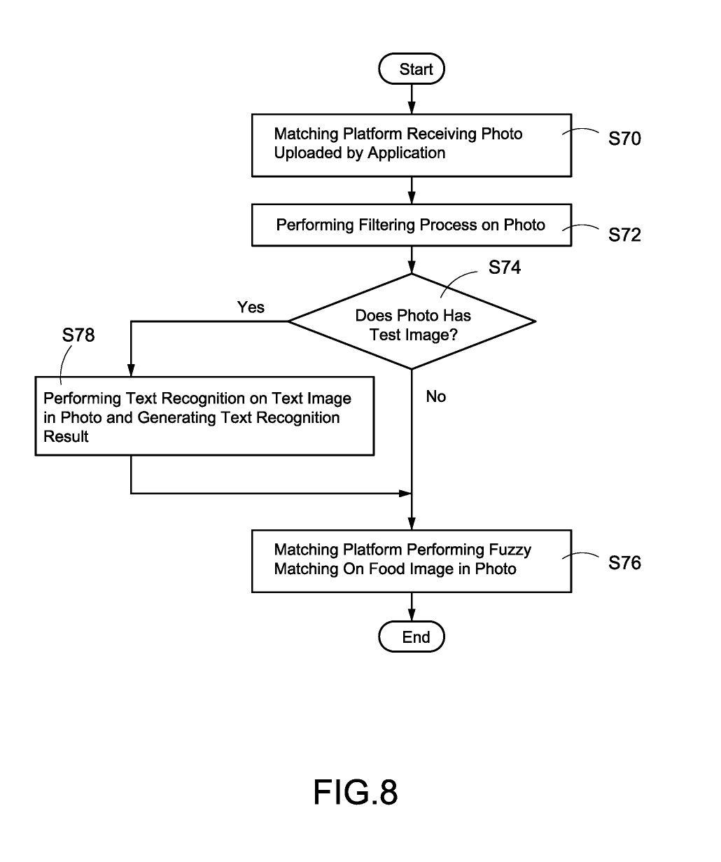

FIG. 8 is a photo process flowchart according to the second embodiment of the present invention. In the embodiment, the matching platform 1 keeps parts or all of a text image (for example the meal dish names in a menu) besides the above mentioned food images when the matching platform 1 performs the filtering process on the photo.

Specifically, the matching platform 1 firstly receives the photo uploaded by the application 40 (step S70), then performs a filtering process on the photo to remove the unnecessary information in the photo (step S72). In the embodiment, the unnecessary information is the images besides the food and the text, but the scope is not limited thereto. Next, the matching platform 1 further determines if the photo has a text image (step S74). Specifically, the matching platform 1 analyzes the photo via known image recognition algorithms to determine if the photo has a text image besides the food image at the same time.

If the matching platform 1 determines that the photo does not have a text image, the matching platform 1 directly performs the fuzzy matching on the food image in the photo as shown in step S24 in FIG. 4 (step S76). Though, if the matching platform 1 determines that the photo has at least a text image, the matching platform 1 first performs text recognition on the text image in the photo to generate a text recognition result (step S78), and performs the fuzzy matching on the food image in the photo as shown in step S24 in FIG. 4 (step S76).

In the embodiment, the matching platform 1 performs multiple fuzzy matchings according to parameters such as the shape, the color, the surface status etc. of the food image in the photo and obtains multiple fuzzy matching results in step S76. In addition, the matching platform 1 generates the final matching result according to both the multiple fuzzy matching results and the text recognition result at the same time. Thus, the food recognition accuracy is effectively increased.

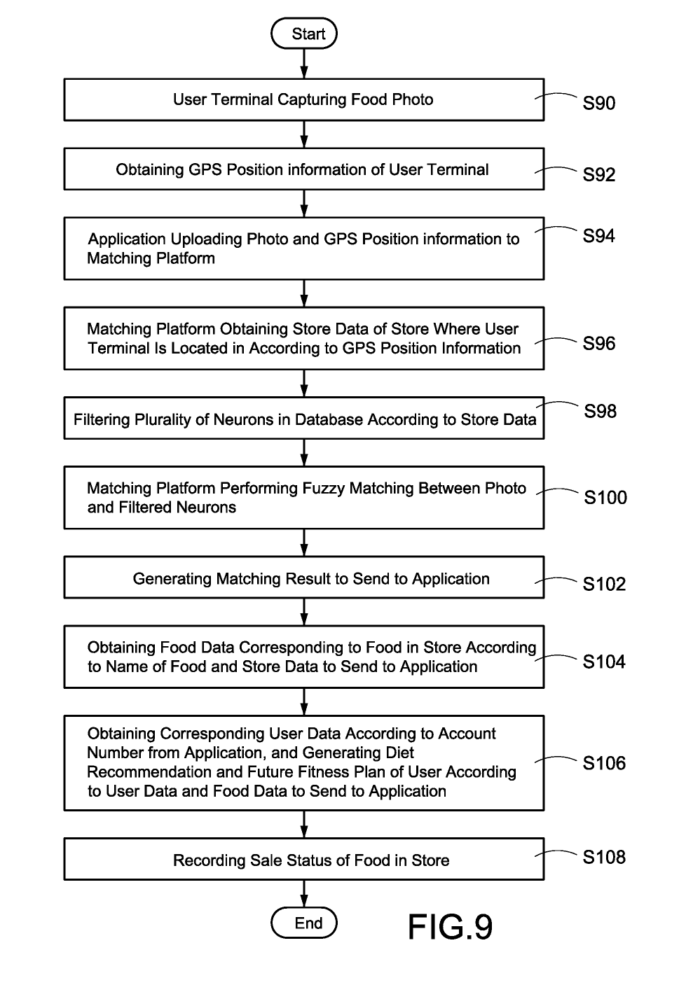

FIG. 9 is a diet information recommendation flowchart according to the second embodiment of the present invention. In the first embodiment shown in FIG. 4, the matching platform 1 performs a fuzzy matching between the uploaded photo from the application 40 and all the neurons 21 in the database 2 to generate a matching result. In the embodiment shown in FIG. 9, the matching platform 1 first filters the neurons 21 in the database 2 to reduce the matching quantity, and then performs a fuzzy matching based on the reduced amount of the neurons 21. Thus, the recognition accuracy is increased and the operation loading of the recommendation system is reduced.

In the embodiment, the user controls a user terminal 4 to capture a photo of food 5 (step S90), and obtains the GPS position information of the user terminal 4 with the position module (not shown in the diagrams) of the user terminal 4 (step S92). Next, the user uploads the photo and the GPS position information to the matching platform 1 through the application 40 (step S94). Next, the matching platform 1 first inquires the database 2 according to the received GPS position information to obtain the associated data of the location the user terminal 4 currently located in before performs the fuzzy matching.

Specifically, the embodiment presumes that the user is currently located in a food sale store and the matching platform 1 obtains the store data 24 as shown in FIG. 2 from the database 2 according to the GPS position information (step S96). In addition, the matching platform 1 filters the plurality of neurons 21 in the database 2 according to the store data 24 (step S98). Specifically, the matching platform 1 is to exclude the neurons 21 from the database 2 corresponding to the food that is not sold in the store where the user is located in.

For example, the matching platform 1 obtains the corresponding store data 24 according to the GPS position information and the store data 24 indicates that the user is in a fruit shop. After step S98, the matching platform 1 only keeps the neuron 2 21 under the fruit category in the database 2, and excludes the neurons 21 under other categories (for example meats, alcohols etc.) from the database 2.

Next, the matching platform 1 performs a fuzzy matching between the photo and the filtered neurons 21 (step S100), generates a matching result after the fuzzy matching, and sends the matching result to the application 40 (step S102). Similarly, the matching result comprises at least the name of the food 5 in the above mentioned photo.

In the embodiment, the matching platform 1 also inquires the database 2 according to both the name of the food and the store data 24 to obtain the food data 22 corresponding to the food 5 in the store and sends the food data 22 to the application 40 (step S104).

Specifically, different stores offer different portions or use different cooking methods with the same food. For example, the stake from shop A is weighted 8 ounces and served with rose salts and another stake from shop B is weighted 6 ounces and served with the black pepper sauce. Both are stakes but the food data 22 obtained may be different (for example portions and calories of both stakes vary). In the embodiment, the matching platform 1 inquires the database 2 according to both the name of the food 5 and the store data 24 so as to ensure the obtained food data 22 sharing more in common with the exact food eaten by the user.

Similarly, in the embodiment, the matching platform 1 obtains the account number of the user from the application 40, inquires the database 2 according to the account number to obtain the corresponding user data 23, generates a diet recommendation and a future fitness plan of the user according to both the user data 23 and the food data 22, and sends the diet recommendation and the future fitness plan to the application 40 (step S106).

It should be note that, in the embodiment, the recommendation system is able to determine which food is ordered in which store via the above mentioned food data 22 and the store data 24. Therefore, the matching platform 1 further records the sale status of the specific food 5 in the specific store (step S108). Thus, the recommendation system developer further sends the sale status feedback to each store so as to keep each store informed of the sale status of each food (each meal dish) in the store.

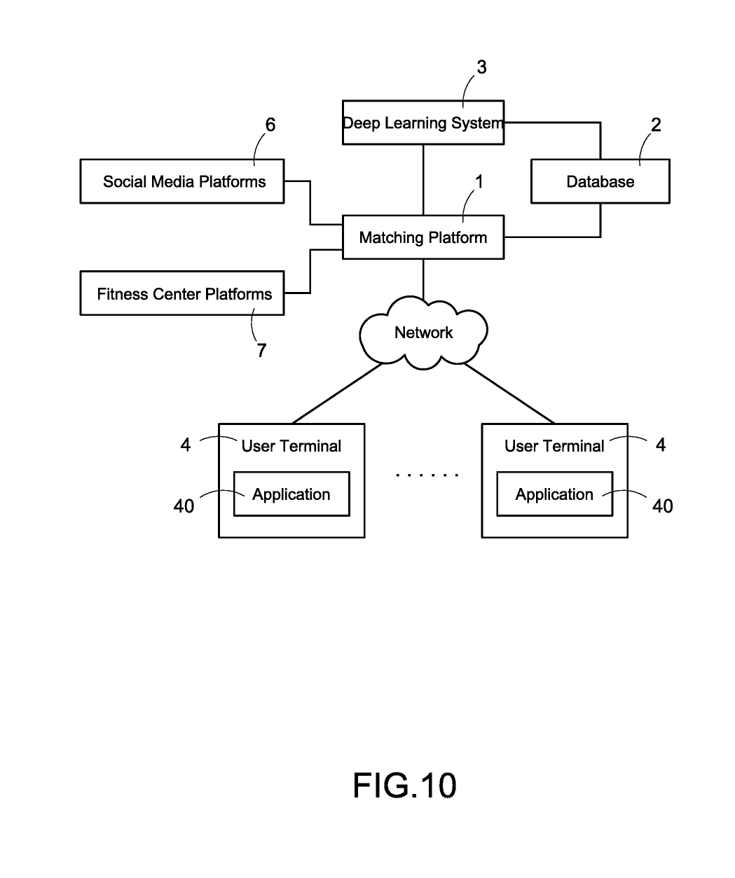

FIG. 10 is a system architecture diagram of a diet information recommendation system according to the first embodiment of the present invention. The difference between the recommendation systems in the embodiments shown in FIG. 1 and FIG. 10 is that the matching platform 1 further connects to social media platforms 6 and fitness center platforms 7 in the recommendation system in FIG. 10.

In the embodiment, the matching platform 1 completes the fuzzy matching, obtains the food data 22 corresponding to the food 5 in the photo and generates the diet recommendation and the fitness plan via the analysis, then the matching platform 1 automatically fills the generated diet recommendation and the generated fitness plan in the account number of the user at the social media platforms 6 and/or the fitness center platforms 7 so as to automatically shares the information. For example, the matching platform 1 automatically shares the photo and the food data 22 in the account of the user at the social media platforms 6 (such as FACEBOOK, GOOGLE+ etc.). In another example, the matching platform 1 automatically logs on to the fitness center platforms 7 with the account number of the user and records the future fitness plan.

In comparison with prior art, the system and method of the present invention provide a technical advantage that users are allowed to conveniently and promptly access food associated data and receives a diet recommendation based on the user personal data from the system which helps the users to control daily diet.

As the skilled person will appreciate, various changes and modifications can be made to the described embodiment. It is intended to include all such variations, modifications and equivalents which fall within the scope of the present invention, as defined in the accompanying claims.

What is claimed is:

1. A diet information recommendation system, comprising:
a database, saved with a plurality of neurons set up in advance, wherein each neuron respectively comprises a picture and a corresponding name;
a matching platform connected to the database;
an application installed in a user terminal, the user terminal establishing a connection with the matching platform via executing the application, and the application uploading a photo of a food captured by the user terminal to the matching platform;
wherein, the matching platform performs a fuzzy matching between the photo and the plurality of neurons in the database to generate a matching result to send to the application, and the matching result at least comprises the name of the food;
wherein, the matching platform inquires the database according to the name of the food to obtain food data corresponding to the food, and sends the food data to the application, and the matching platform obtains user data corresponding to an account number of the application from the database, and generates a diet recommendation according to the user data and the food data to send to the application.

2. The diet information recommendation system of claim 1, wherein the user data at least comprises a current fitness plan of a user, the matching platform generates a future fitness plan according to the user data and the food data to send to the application after the matching platform obtains the user data from the database.

3. The diet information recommendation system of claim 1, further comprising a deep learning system connected to the matching platform and the database, wherein the deep learning system sets names of each of the plurality of pictures uploaded to the database and categories the plurality of pictures according to the set names in order to set up the plurality of neurons.

4. The diet information recommendation system of claim 3, wherein the matching platform transfers the photo and the matching result to the deep learning system upon determining the matching result is correct, and the deep learning system updates the plurality of neurons in the database according to the photo and the matching result.

5. The diet information recommendation system of claim 4, wherein the matching platform receives a correct name input externally and transfers the photo and the correct name to the deep learning system upon determining the matching result is incorrect, and the deep learning system updates the plurality of neurons in the database according to the photo and the correct name.

6. The diet information recommendation system of claim 3, wherein the matching platform performs one or multiple fuzzy matchings according to at least one of shape, color, surface status, dimension, cooking method and recipe of a food image in the photo and obtains one or multiple fuzzy matching results, wherein the matching result comprises one or multiple names generated according to the one or multiple fuzzy matching results, and comprises the probability percentage of each generated name.

7. The diet information recommendation system of claim 6, wherein the matching platform performs a filtering process on the photo to remove unnecessary information from the photo; and the matching platform performs a text recognition on a text image to generate a text recognition result when the photo comprises the text image, and generates the matching result according to both the one or multiple fuzzy matching results and the text recognition result.

8. The diet information recommendation system of claim 3, wherein, the matching platform performs a filtering process on the photo to remove unnecessary information besides a food image; and the matching platform divides multiple food images from the photo when the photo comprises multiple food images, and respectively performs a fuzzy matching on each food image and respectively generates the corresponding matching result for each food image.

9. The diet information recommendation system of claim 3, wherein, the application uploads GPS position information of the user terminal to the matching platform, the matching platform inquires the database according to the GPS position information to obtain store data of a store where the user terminal is located in, and filters the plurality of neurons in the database according to the store data and then performs a fuzzy matching between the photo and the filtered neurons.

10. The diet information recommendation system of claim 9, wherein, the matching platform inquires the database according to both the name of the food in the photo and the store data to obtain the corresponding food data of the food in the store, and sends the food data to the application.

11. The diet information recommendation system of claim 9, wherein the matching platform records a sale status of the food in the store.

12. A diet information recommendation method adopted by a diet information recommendation system comprising a database, a matching platform, and an application installed in a user terminal, and the diet information recommendation method comprising:
a) the application uploading a photo of a food captured by the user terminal to the matching platform;
b) the matching platform performing a fuzzy matching between the photo and a plurality of neurons in the database to generate a matching result to send to the application, wherein each neuron respectively comprises a picture and a corresponding name, and the matching result at least comprises the name of the food;
c) the matching platform inquiring the database according to the name of the food to obtain food data corresponding to the food, and sending the food data to the application;
d) the matching platform obtaining user data corresponding to an account number of the application from the database; and
e) generating a diet recommendation according to the user data and the food data to send to the application.

13. The diet information recommendation method of claim 12, wherein the user data at least comprises a current fitness plan of a user, and the diet information recommendation method further comprises a step f: after step d, generating a future fitness plan according to the user data and the food data to send to the application.

14. The diet information recommendation method of claim 12, wherein the diet information recommendation system further comprises a deep learning system, and the diet information recommendation method further comprises the following steps:
g) the application determining if the matching result is correct;
h) the matching platform transferring the photo and the matching result to the deep learning system upon determining the matching result is correct;
i) after step h, the deep learning system updating the plurality of neurons in the database according to the photo and the matching result;
j) the application receiving a correct name input externally and uploading the correct name to the matching platform upon determining the matching result is incorrect;
k) after step j, the matching platform transferring the photo and the correct name to the deep learning system;
i) after step k, the deep learning system updating the plurality of neurons in the database according to the photo and the correct name;

15. The diet information recommendation method of claim 12, wherein the step b performs one or multiple fuzzy matchings according to at least one of shape, color, surface status, dimension, cooking method and recipe of a food image in the photo and obtains one or multiple fuzzy matching results, wherein the matching result comprises one or multiple names generated according to the one or multiple fuzzy matching results, and comprises the probability percentage of each name.

16. The diet information recommendation method of claim 15, further comprising following steps:
m1) after step a, the matching platform performing a filtering process on the photo to remove the unnecessary information from the photo;
m2) executing step b according to the food image upon determining the photo has only one food image; and
m3) dividing multiple food images upon determining the photo has multiple food images and executing step b respectively according to each of the multiple food images.

17. The diet information recommendation method of claim 15, further comprising following steps:
n1) after step a, the matching platform performing a filtering process on the photo to remove the unnecessary information besides the food image;
n2) executing step b according to the food image upon determining the photo does not have a text image; and
n3) performing text recognition on a text image to generate a text recognition result and executing step b according to the food image upon determining the photo has the text image; and
wherein, the step b generates the matching result according to both the one or multiple fuzzy matching results and the text recognition result.

18. The diet information recommendation method of claim 12, further comprising following steps:
a1) the application uploading GPS position information of the user terminal to the matching platform;
a2) the matching platform inquiring the database according to the GPS position information to obtain store data of a store where the user terminal is located in;
a3) filtering the plurality of neurons in the database according to the store data;
and
wherein the step b performs the fuzzy matching between the photo and the filtered neurons.

19. The diet information recommendation method of claim 18, wherein the step c inquires the database according to both the name of the food in the photo and the store data to obtain the corresponding food data of the food in the store, and sends the food data to the application.

20. The diet information recommendation method of claim 19, wherein, further comprising a step o: the matching platform recording a sale status of the food in the store.
